(19) United States
(12) Patent Application Publication
(10) Pub. No.: US 2023/0104177 A1
(43) Pub. Date: Apr. 6, 2023

(54) CLEANING ARTICLE

(71) Applicant: Carl Freudenberg KG, Weinheim (DE)

(72) Inventors: Friedel Winterling, Ludwigshafen (DE); Norbert Weis, Weinheim (DE); Stephen Dickel, Mannheim (DE); Robert G Challman, Naperville, IL (US); Sabine Boroyevich, Richardson, TX (US); Robert Ancheta, Aurora, IL (US); Doug Metzel, Lombard, IL (US); Eric Martin, St. Charles, IL (US)

(73) Assignee: Carl Freudenberg KG, Weinheim (DE)

(21) Appl. No.: 18/062,974

(22) Filed: Dec. 7, 2022

Related U.S. Application Data
(63) Continuation-in-part of application No. 17/478,700, filed on Sep. 17, 2021, now Pat. No. 11,564,549.

(51) Int. Cl. A47L 13/38; B32B 7/05

(52) U.S. Cl. CPC A47L 13/38; B32B 7/05; B32B 5/022

(57) ABSTRACT

A cleaning article includes: a first panel having: a first fiber layer; and a first substrate attached to the first fiber layer by a first connection type; and a second panel having: a second fiber layer; and a second substrate attached to the second fiber layer by the first connection type. The first connection type includes a first connection line in parallel with a second connection line, the first and second connection lines together straddling a center line of a respective panel that extends in an axial direction. The first panel is attached to the second panel by a plurality of spot connections so as to create a pocket between the first panel and the second panel.

### CROSS-REFERENCE TO PRIOR APPLICATION

This application is a continuation-in-part of U.S. patent application Ser. No. 17/478,700, filed on Sep. 17, 2021, the entire disclosure which is hereby incorporated by reference herein.

### FIELD

The present disclosure generally relates to a cleaning article for mounting to a cleaning tool. The cleaning article may be used as a refill for the cleaning tool.

### BACKGROUND

In general, cleaning tools with cleaning articles (e.g., dusters) attachable thereto are known in the art. The cleaning articles can be removable from the cleaning tool so that if the cleaning article becomes overly soiled or used, the cleaning article can be removed and a new cleaning article can be attached in its place. Oftentimes an engagement portion of the cleaning tool is inserted into the cleaning article so that the cleaning article covers one end of the cleaning tool, such as the end opposite the handle of the cleaning tool. In this manner, a user of the cleaning tool can grasp the handle and maneuver the cleaning article to clean appropriately. Such arrangements are useful because they allow the user to more easily clean harder to reach places (e.g., by extending the user's reach).

Cleaning articles often have a plurality of fibers attached thereto to attract dust and other debris as the cleaning article passes over the surface to be cleaned. In order to attain better cleaning and improve aesthetics, it is desirable to avoid portions of the cleaning article where no fibers are present.

### SUMMARY

In an embodiment, the present invention provides a cleaning article, comprising: a first panel, comprising: a first fiber layer; and a first substrate attached to the first fiber layer by a first connection type; and a second panel, comprising: a second fiber layer; and a second substrate attached to the second fiber layer by the first connection type, wherein the first connection type comprises a first connection line in parallel with a second connection line, the first and second connection lines together straddling a center line of a respective panel that extends in an axial direction, and wherein the first panel is attached to the second panel by a plurality of spot connections so as to create a pocket between the first panel and the second panel.

### BRIEF DESCRIPTION OF THE DRAWINGS

FIG. 1 shows a schematic view of a panel of a cleaning article according to the present disclosure;

FIG. 2 shows a schematic view of a panel of a cleaning article according to the present disclosure;

FIG. 3 shows a perspective view of a panel of a cleaning article according to the present disclosure;

FIG. 4 shows a perspective view of a cleaning article according to the present disclosure attached to a cleaning tool;

FIG. 5 shows a perspective view of a cleaning article according to the present disclosure attached to a cleaning tool;

FIG. 6 shows a process of making a cleaning article according to the present disclosure; and

FIG. 7 shows cleaning articles according to the present disclosure at various stages during the process of FIG. 6.

### DETAILED DESCRIPTION

To improve upon the prior art, the present application describes a cleaning article whose connection lines are less visible. The cleaning article also has a 360° look, which not only improves aesthetics but increases the functionality of the cleaning article as all sides of the cleaning article can be used for cleaning. The cleaning article can be attached to a cleaning tool, such as that described U.S. patent application Ser. No. 17/478,700, and used as a refill once an existing cleaning article is no longer suitable for cleaning.

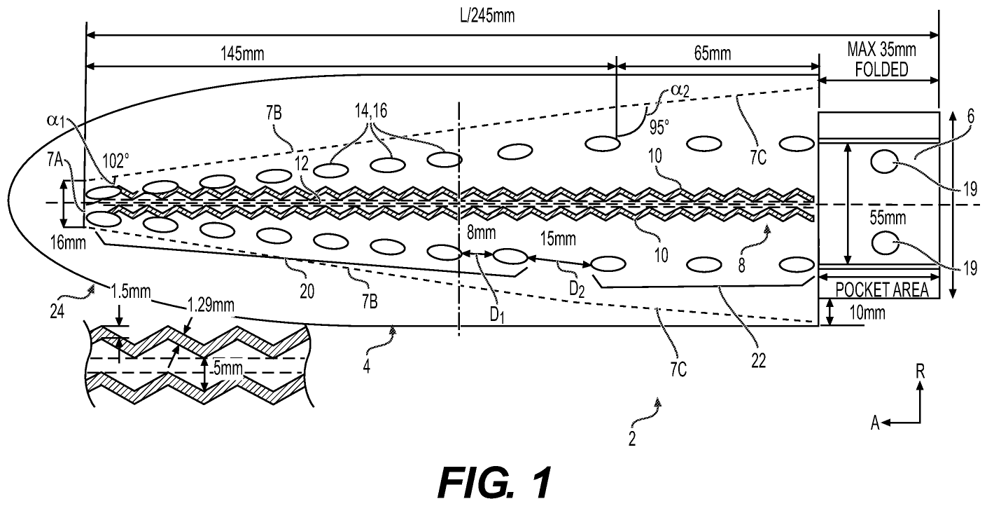

FIG. 1 shows a schematic view of an exemplary panel 2 according to the present application. Two such panels 2 are connected to one another in order to form a cleaning article. For simplicity, however, discussion will initially focus on one individual panel 2.

Panel 2 is prepared by taking a fiber layer 4 and attaching it to a substrate 6. Fiber layer 4 includes a plurality of cleaning fibers that are used to collect dust and debris during cleaning with the cleaning article. The cleaning fibers extend generally in radial direction R. The cleaning ability of the cleaning fibers may be increased by spraying the cleaning fibers with oil. The cleaning fibers may be made from polyester, either as a virgin material, a recycled material, or a mix thereof, and have a mass in grams for every 10,000 meters of fiber of approximately 2.5 dtex to 3.5 dtex. Adding virgin material to the cleaning fibers helps facilitate connection of fiber layer 4 to substrate 6.

Substrate 6 may be, for example, a nonwoven sheet. The nonwoven sheet could be made from a spunbond nonwoven material such as polyester and/or polypropylene, and the material could be either virgin or recycled, or a mix thereof. The nonwoven sheet could have a weight of approximately 35 g/m². Substrate 6 has a substrate edge 7. Substrate edge 7, in turn, has various components, which will be explained in further detail below.

Fiber layer 4 is attached to substrate 6 using a first connection type 8. First connection type 8 may be a connection type known in the art. In an embodiment, first connection type 8 includes two separate connection lines 10 that extend along length L of panel 2 in axial direction A. Each connection line 10 can each be, for example, an ultrasonic weld having a specific shape, the ultrasonic weld being formed by ultrasonic welding techniques. A width of a connection line 10 can be approximately 1.29 mm or 1.5 mm. Each connection line 10 is to one side of a center line 12 of panel 2 such that connection lines 10 together straddle center line 12. The distance from a first connection line 10 on one side of center line 12 to a second connection line 10 on the other side of center line 12 can be approximately 5 mm. Cleaning fibers of fiber layer 4 cover center line 12 after assembly of the cleaning article, which makes center line 12 less visible and helps create the 360° look of the cleaning article.

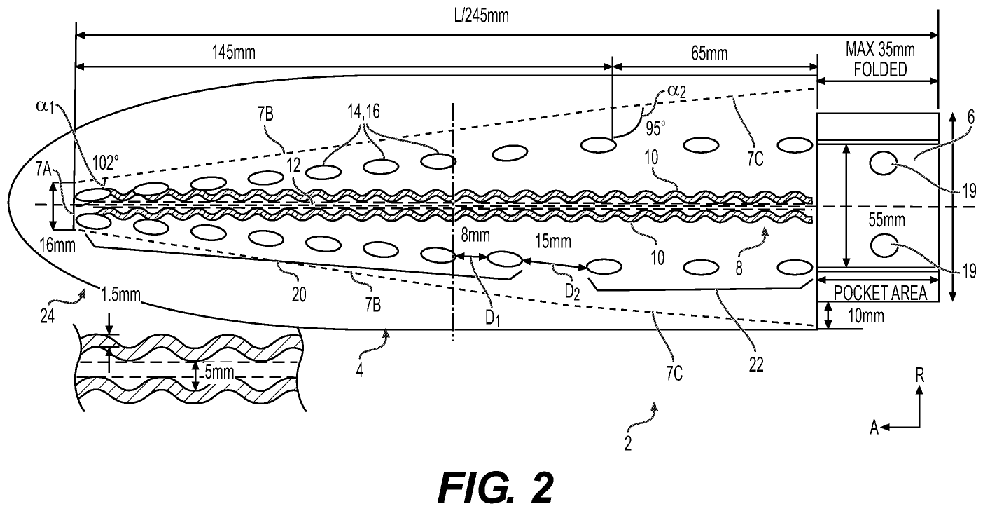

Connection lines 10 may have a particular shape. For example, each connection line 10 may have a zig-zag shape (as shown in FIG. 1) or a wave shape (as shown in FIG. 2). The two connection lines 10 can be parallel to one another. Various exemplary dimensions of the connection lines 10, and panel 2 as a whole, are shown in FIGS. 1-2.

Once panel 2 is prepared, panel 2 is attached to another identical panel 2 in order to make the cleaning article. Specifically, the two panels 2 are lined up one on top of the other and then connected to one another using a second connection type 14. Second connection type 14 may be a connection type known in the art. Second connection type 14 can comprise a plurality of spot connections 16. In an embodiment, each spot connection 16 can be an ultrasonic weld having a specific shape, the ultrasonic weld being formed by ultrasonic welding techniques. For example, spot connections 16 can have a generally oval or circular shape with a major axis of approximately 5 mm in length and a minor axis of approximately 3 mm in length. The plurality of spot connections 16 are applied along length L and are generally symmetric and radially offset with respect to center line 12. Connecting two panels 2 together in this manner creates a pocket 18 between the two panels 2. Consequently, the cleaning tool can be inserted into pocket 18 of the cleaning article so that the cleaning article can be affixed to the cleaning tool, for example, by hooking at least a portion of the cleaning tool into holes 19 in substrate 6.

As shown in FIGS. 1-2, the plurality of spot connections 16 can be divided into at least two distinct sets. In first set 20, on one side of center line 12 a given spot connection 16 is at a first distance D₁ from an adjacent spot connection 16. In second set 22, on one side of center line 12 a given spot connection 16 is at a second distance D₂ from an adjacent spot connection 16. Second distance D₂ is greater than first distance D₁. First set 20 of spot connections 16 is arranged toward tip end 24 of panel 2, whereas second set 22 of spot connections 16 is arranged toward a handle end 26 of panel 2, closer to where a cleaning tool would be inserted into pocket 18. In this manner, spot connections 16 of first set 20 are closer together at tip end 24 to assure a good fit for the cleaning tool and that the cleaning tool does not poke through pocket 18 of the cleaning article during insertion and cleaning. Spot connections 16 of second set 22, however, are spaced farther apart to create a wider insertion area for pocket 18 and to contribute to the 360° look of the cleaning article.

The arrangement of spot connections 16 described herein also contributes to the loose ends of the cleaning fibers of fiber layers 4 having different lengths. For example, some cleaning fibers are connected to one another only by connection lines 10 of first connection type 8, whereas other cleaning fibers are connected to one another by both connection lines 10 of first connection type 8 and a spot connection 16 of second connection type 14. The loose ends of the cleaning fibers having a variety of different lengths helps improve the cleaning ability of the cleaning article.

First set 20 of spot connections 16 and second set 22 of spot connections 16 also generally correspond to the different components of substrate edge 7. In particular, leading edge 7A of substrate edge 7 is at tip end 24 of panel 2, adjacent one end of first set 20 of spot connections 16. Leading edge 7A generally extends in radial direction R.

Extending from leading edge 7A on either side of center line 12 are first lengthwise edges 7B. First lengthwise edges 7B generally extend in axial direction A approximately as far as first set 20 of spot connections 16 extends along length L of panel 2. An angle between leading edge 7A and a first lengthwise edge 7B is first angle α₁. First angle α₁ is greater than 90°. For example, first angle α₁ could be 102°, as shown in FIGS. 1-2.

When continuing along length L of panel 2, first lengthwise edges 7B adjoin second lengthwise edges 7C. Second lengthwise edges 7C generally extend in axial direction A approximately as far as second set 22 of spot connections 16 extends along length L of panel 2. An angle between leading edge 7A and a second lengthwise edge 7C is second angle α₂. Second angle α₂ is also greater than 90°. For example, second angle α₂ could be 95°, as shown in FIGS. 1-2.

First angle α₁ is greater than second angle α₂. In this manner, for a given substrate 6, first lengthwise edge 7B and second lengthwise edge 7C on one side of center line 12 are not parallel to first lengthwise edge 7B and second lengthwise edge 7C, respectively, on the other side of center line 12. Each substrate 6 (i.e., as each substrate 6 appears in the assembled cleaning article) may therefore generally have the shape of a triangle, cone, or arrow, the lengthwise edges of which are not parallel.

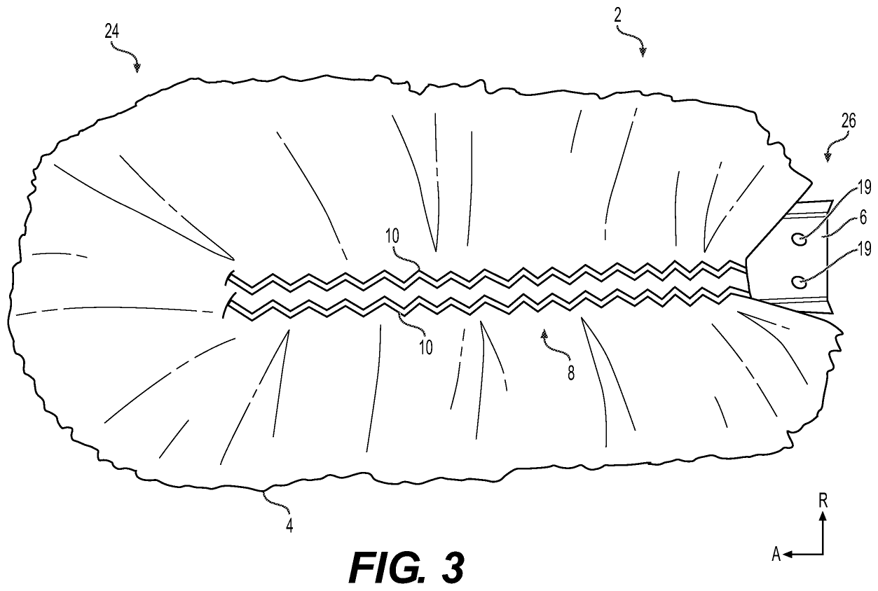

FIG. 3 shows a perspective view of one panel 2 after it has been assembled. This panel 2 includes zig-zag connection lines 10, as in FIG. 1. The cleaning fibers of fiber layer 4 extend from connection lines 10 in both the radial direction R and the axial direction A. Substrate 6 is visible and accessible near handle end 26 of panel 2. Substrate 6 includes holes 19 for attaching at least a part of a cleaning tool in order to retain panel 2 (and the other panel 2 to which it is attached) on the cleaning tool.

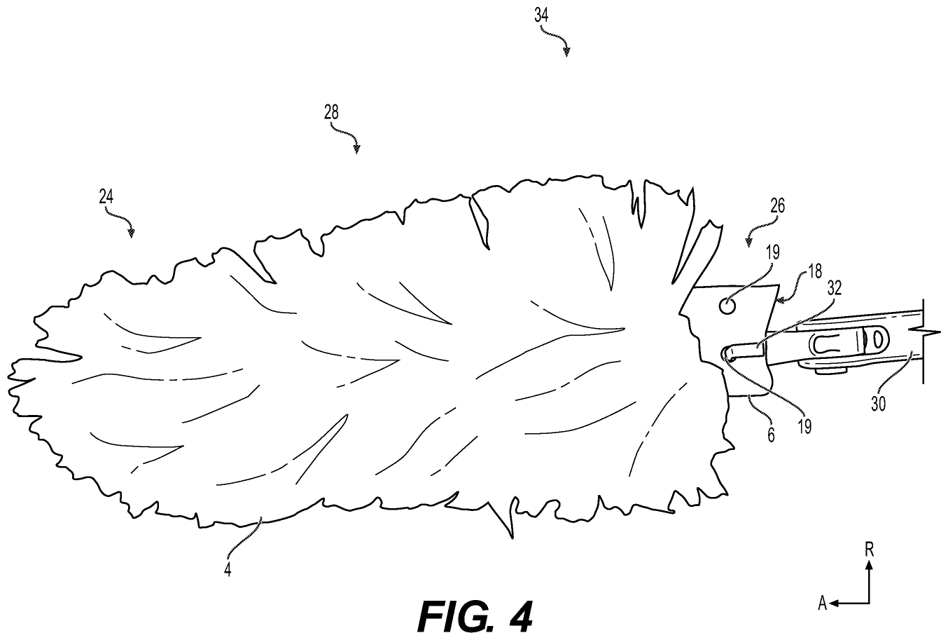

FIG. 4 shows a perspective view of two panels 2 after they have been assembled, for example, by being connected with second connection type 14 (e.g., plurality of spot connections 16). The two connected panels 2 together form cleaning article 28. When the two panels 2 are connected to one another, in general neither connection lines 10 of first connection type 8, nor spot connections 16 of second connection type 14 are visible upon cursory inspection of cleaning article 28. As shown, cleaning article 28 also does not include any area of its cross section where no cleaning fibers (i.e., of fiber layers 4) are present, helping contribute to an overall 360° look of cleaning article 28.

As shown in FIG. 4, a cleaning tool 30 has been inserted into pocket 18 of cleaning article 28, which pocket 18 is formed after the two panels 2 are connected to one another. In order to secure cleaning tool 30 to cleaning article 28, at least one protrusion 32 of cleaning tool 30 has been hooked into hole 19 on substrate 6 of one of the panels 2. In this manner, cleaning article 28 is secured to cleaning tool 30 and held in place by protrusion 32 while a user uses the resulting cleaning device 34 to clean or dust.

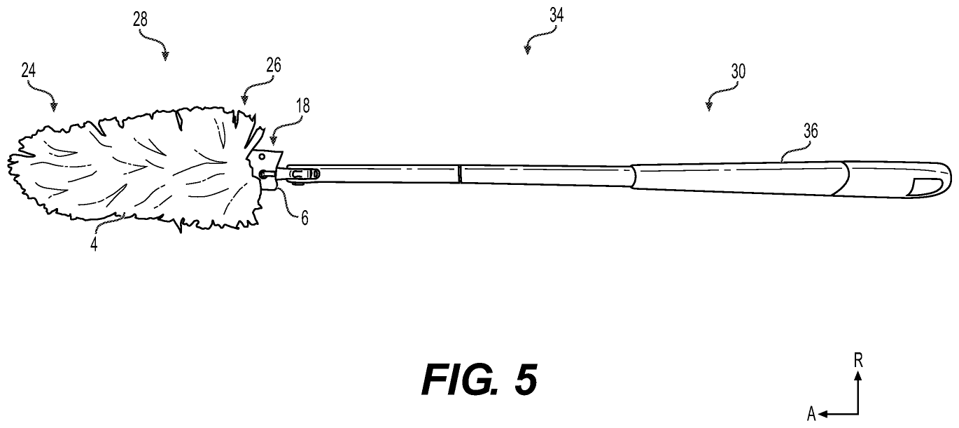

FIG. 5 shows a broader view of cleaning device 34 of FIG. 4. As can be seen, cleaning tool 30 includes a handle 36 graspable by the user of the cleaning device 34 in order to maneuver cleaning article 28 when cleaning article 28 is attached to cleaning tool 30. Cleaning tool may be essentially as described in the parent of the present application, U.S. patent application Ser. No. 17/478,700, filed on Sep. 17, 2021.

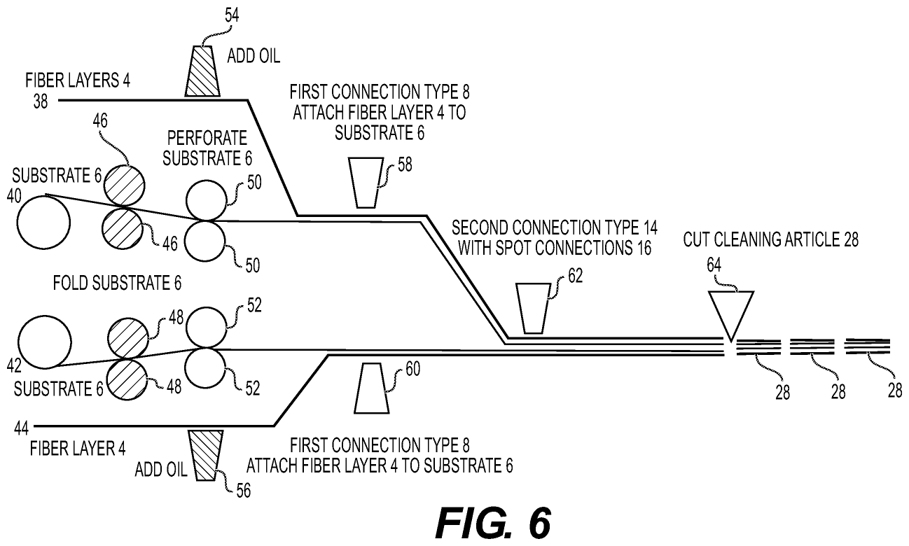

FIG. 6 shows a simplified method for making cleaning articles 28. As can be seen, the method includes four process lines. First process line 38 and second process line 40 combine to make a first panel 2. In particular, first process line 38 includes a continuous roll of fiber layer 4 and second process line 40 is arranged adjacent thereto and includes a continuous roll of substrate 6. Meanwhile, third process line 42 and fourth process line 44 combine to make a second panel 2. In particular, third process line 42 includes a continuous roll of fiber layer 4 and fourth process line 44 is arranged adjacent thereto and includes a continuous roll of substrate 6. First process line 38 and second process line 40 are arranged generally adjacent to (e.g., above) third process line 42 and fourth process line 44.

In a first step of the method, substrate 6 from second process line 40 and substrate 6 from third process line 42 each pass through a pair of rollers 46, 48, respectively. In passing through pairs of rollers 46, 48, each substrate 6 is folded on one end thereof. These ends will ultimately become the portions of each substrate 6 that form pocket 18. Folding the ends of each substrate 6 helps to structurally reinforce those areas and ultimately structurally reinforce the portion of pocket 18 near handle end 26 of cleaning article 28. For example, due to the folds, substrate 6 of each panel 2 becomes twice as thick, facilitating a strong attachment of cleaning article 28 to protrusion 32 when the completed cleaning article 28 is affixed to cleaning tool 30. Folding each substrate 6 also helps facilitate connection of substrate 6 of a first panel 2 to substrate 6 of a second panel 2, extending pocket 18 to include the folded portions of each substrate 6.

In a next step, still in second process line 40 and third process line 42, the folded substrates 6 each pass through other pairs of rollers 50, 52, respectively. In this step, rollers 50, 52 perforate substrates 6. Perforating substrates 6 forms substrate edges 7 and facilitates separation of each individual substrate 6 from its continuous roll later in production. At or about the same time, in first process line 38 and fourth process line 44, a first fiber layer 4 and a second process layer 4 each pass adjacent to oil sprayers 54, 56, respectively. Oil sprayers 54, 56 apply a light coating of oil to first and second fiber layers 4. For example, each oil sprayer 54, 56 can apply about 0.5 g of oil to its respective fiber layer 4.

In a next step, fiber layer 4 from first process line 38 and substrate 6 from second process line 40 are brought closer to one another in order to attach fiber layer 4 and substrate 6 using first connection type 8. Similarly, fiber layer 4 from third process line 42 and substrate 6 from fourth process line 44 are brought closer to one another in order to attach fiber layer 4 and substrate 6, also using first connection type 8. In particular, connection device 58 can be used to apply first connection type 8 to connect fiber layer 4 of first process line 38 to substrate 6 of second process line 40 to create a first panel 2. Moreover, connection device 60 can be used to apply first connection type 8 to connect fiber layer 4 of third process line 42 to substrate 6 of fourth process line 44 to create a second panel 2. Connection devices 58, 60 can be, for example, ultrasonic welding machines.

Next, first panel 2 of first process line 38 and second process line 40 is brought closer to second panel 2 of third process line 42 and fourth process line 44 in order to attach first panel 2 and second panel 2 using second connection type 14. In particular, connection device 62 can be used to apply second connection type 14 (e.g., a plurality of spot connections 16) to connect first panel 2 of first process line 38 and second process line 40 to second panel 2 of third process line 42 and fourth process line 44. Connection device 62 can be, for example, an ultrasonic welding machine.

Finally, the combined first panel 2 and second panel 2 pass through a cutting device 64 to create cleaning articles 28, each successive cut of cutting device 64 separating an additional cleaning article 28 from the combined continuous rolls of material.

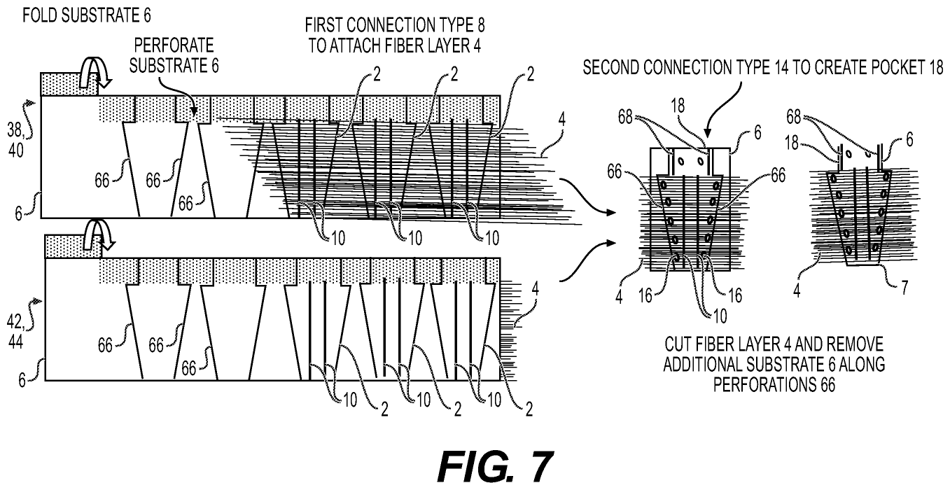

FIG. 7 shows cleaning articles 28 at various stages during the method of FIG. 6. The top left-hand side of FIG. 7 shows fiber layer 4 of first process line 38 and substrate 6 of second process line 40 as they are being combined. Initially, substrate 6 is folded. Next, substrate 6 is perforated with perforations 66 to facilitate forming substrate edges 7 for substrates 6. Thereafter, fiber layer 4 is attached to substrate 6 using first connection type 8 (i.e., by forming connection lines 10) to create a roll of first panels 2. As shown in the bottom left-hand side of FIG. 7, these same steps are performed with fiber layer 4 of third process line 42 and substrate 6 of fourth process line 44 to create a roll of second panels 2. The roll of second panels 2 is flipped with respect to the roll of first panels 2.

As shown in the middle image of FIG. 7, a first panel 2 (i.e., a panel 2 created by first process line 38 and second process line 40) and a second panel 2 (i.e., a panel 2 created by third process line 42 and fourth process line 44) are connected using a second connection type 14 (e.g., a plurality of spot connections 16), creating pocket 18 between first panel 2 and second panel 2. Additional connection lines 68 may be applied to connect the portions of substrate 6 of first and second panels 2 without fiber layers 4 to further define and structurally reinforce pocket 18, and specifically the portion of pocket 18 into which cleaning tool 30 is initially inserted.

Thereafter, as shown in the right-hand side of FIG. 7, excess portions of each substrate 6 are removed along perforations 66, forming substrate edge 7. Furthermore, the cleaning fibers of fiber layers 4 of each panel 2 are then cut in order to provide the resulting cleaning article 28 with a desired shape.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

2 panel
4 cleaning article
6 substrate
7 substrate edge
7A leading edge
7B first lengthwise edge
7C second lengthwise edge
8 first connection type
connection line
12 center line
14 second connection type
16 spot connection
18 pocket
19 holes
first set
22 second set
24 tip end
26 handle end
28 cleaning article
30 cleaning tool
32 protrusion
34 cleaning device
36 handle
38 first process line
40 second process line
42 third process line
44 fourth process line
46 rollers
48 rollers
50 rollers
52 rollers
54 oil sprayer
56 oil sprayer
58 connection device
60 connection device
62 connection device
64 cutting device
66 perforation
68 additional connection line
α₁ first angle
α₂ second angle
A axial direction
D₁ first distance
D₂ second distance
L length of panel 2
R radial direction

What is claimed is:

1. A cleaning article, comprising:
a first panel, comprising:
a first fiber layer; and
a first substrate attached to the first fiber layer by a first connection type; and
a second panel, comprising:
a second fiber layer; and
a second substrate attached to the second fiber layer by the first connection type,
wherein the first connection type comprises a first connection line in parallel with a second connection line, the first and second connection lines together straddling a center line of a respective panel that extends in an axial direction, and
wherein the first panel is attached to the second panel by a plurality of spot connections so as to create a pocket between the first panel and the second panel.

2. The cleaning article of claim 1, wherein the first substrate and the second substrate each have a leading edge extending in a radial direction, a first lengthwise edge extending in the axial direction, the first lengthwise edge adjoining the leading edge, and a second lengthwise edge extending in the axial direction, the second lengthwise edge adjoining the first lengthwise edge.

3. The cleaning article of claim 2, wherein, for the respective panel, the first lengthwise edge makes a first angle with respect to the leading edge and the second lengthwise edge makes a second angle with respect to the leading edge.

4. The cleaning article of claim 3, wherein the first angle is greater than the second angle.

5. The cleaning article of claim 2, wherein the plurality of spot connections comprises a first set of spot connections and a second set of spot connections,
wherein the first set of spot connections extends along a length of the respective panel approximately as far as the first lengthwise edges extend in the axial direction, and
wherein second set of spot connections extends along the length of the respective panel approximately as far as the second lengthwise edges extend in the axial direction.

6. The cleaning article of claim 1, wherein the first substrate and the second substrate each have two first lengthwise edges, one on either side of the center line of the respective panel, and two second lengthwise edges, one on either side of the center line of the respective panel, all lengthwise edges generally extending in the axial direction,
wherein, for the respective panel, the two first lengthwise edges are not parallel to one another, and
wherein, for the respective panel, the two second lengthwise edges are not parallel to one another.

7. The cleaning article of claim 6, wherein, on either side of the center line of the respective panel, one first lengthwise edge adjoins one second lengthwise edge.

8. The cleaning article of claim 7, wherein the first substrate and the second substrate each have a leading edge extending in a radial direction, and
wherein, for the respective panel, the leading edge adjoins each of the two first lengthwise edges.

9. The cleaning article of claim 1, wherein the plurality of spot connections comprises a first set of spot connections and a second set of spot connections,
wherein spot connections of the first set of spot connections are separated from one another by a first distance, and
wherein spot connections of the second set of spot connections are separated from one another by a second distance.

10. The cleaning article of claim 9, wherein the second distance is greater than the first distance.

11. The cleaning article of claim 10, wherein the cleaning article has a tip end and a handle end opposite the tip end, and
wherein the first set of spot connections is closer to the tip end and the second set of spot connections is closer to the handle end.

12. The cleaning article of claim 1, wherein the first and second connection lines each have a zigzag shape.

13. The cleaning article of claim 1, wherein the first and second connection lines each have a wave shape.

14. A cleaning tool, comprising:
the cleaning article of claim 1; and
a flexible skeletal element configured to be coupled with a handle assembly, the flexible skeletal element comprising:
a base;
at least three elongated arms, each of the at least three elongated arms have a base end and a distal end, the base ends extending from the base and being spaced apart from one another at the base, the elongated arms being flexible and resilient;
a plurality of cross-members extending between the elongated arms; and
a plurality of living hinges disposed between the plurality of cross-members and the elongated arms,
wherein a force applied to at least one of the elongated arms is transmitted to at least one of the other of the elongated arms by the plurality of cross-members and the plurality of living hinges, and
wherein the cleaning article is disposed on the flexible skeletal element.

15. The cleaning tool of claim 14, wherein the first substrate and the second substrate each have a leading edge extending in a radial direction, a first lengthwise edge extending in the axial direction, the first lengthwise edge adjoining the leading edge, and a second lengthwise edge extending in the axial direction, the second lengthwise edge adjoining the first lengthwise edge.

16. The cleaning tool of claim 15, wherein, for the respective panel, the first lengthwise edge makes a first angle with respect to the leading edge and the second lengthwise edge makes a second angle with respect to the leading edge.

17. The cleaning tool of claim 16, wherein the first angle is greater than the second angle.

18. A method of making a cleaning article, comprising:
creating a first panel by attaching a first fiber layer to a first substrate using a first connection line in parallel with a second connection line, the first and second connection lines together straddling a center line of the first panel that extends in an axial direction;
creating a second panel by attaching a second fiber layer to a second substrate using a third connection line in parallel with a fourth connection line, the third and fourth connection lines together straddling a center line of the second panel that extends in the axial direction; and
attaching the first panel to the second panel using a plurality of spot connections so as to create a pocket between the first panel and the second panel.

19. The method of claim 18, wherein the first substrate and the second substrate each have two first lengthwise edges, one on either side of the center line of the respective panel, and two second lengthwise edges, one on either side of the center line of the respective panel, all lengthwise edges generally extending in the axial direction,
wherein, for the respective panel, the two first lengthwise edges are not parallel to one another, and
wherein, for the respective panel, the two second lengthwise edges are not parallel to one another.

20. The method of claim 19, wherein, on either side of the center line of the respective panel, one first lengthwise edge adjoins one second lengthwise edge,
wherein the first substrate and the second substrate each have a leading edge extending in a radial direction, and
wherein, in the respective panel, the leading edge adjoins each of the two first lengthwise edges.
